(19) United States
(12) Patent Application Publication
(10) Pub. No.: US 2020/0394653 A1
(43) Pub. Date: Dec. 17, 2020

(54) SERVICE PROVISION METHOD AND APPARATUS FOR DETERMINING APPROVAL OF MULTIPLE USERS AND PROVIDING SERVICE

(71) Applicant: Hyun Jin LIM, Seoul (KR)

(72) Inventor: Hyun Jin LIM, Seoul (KR)

(21) Appl. No.: 16/971,659

(22) PCT Filed: Jan. 13, 2020
(86) PCT No.: PCT/KR2020/000552

§ 371 Date: Aug. 20, 2020

(30) Foreign Application Priority Data
Jan. 14, 2019 (KR) 10-2019-0004886

(51) Int. Cl. G06Q 20/40; H04L 9/14; H04L 9/08; G06Q 20/38

(52) U.S. Cl. CPC G06Q 20/401; H04L 9/14; H04L 9/085; G06Q 2220/00; G06Q 20/3829; H04L 2209/56; G06Q 20/3825

(57) ABSTRACT

A service provision method and apparatus for determining approval or non-approval of a plurality of users and providing a service are provided. A service provision apparatus according to an embodiment of the present disclosure includes a memory storing n secret keys and a processor configured to perform authentication for a first terminal from among the n terminals on the basis of an electronic signature value generated in the first terminal, to request any one of the n secret keys and a message, to check whether n secret keys received from the n terminals are consistent with the n secret keys stored in the memory, to execute the service when the n secret keys and messages, and to request the secret key and the message about approval or non-approval when the n secret keys received from the n terminals are not consistent with the n secret keys stored in the memory.

### CROSS-REFERENCE TO RELATED APPLICATIONS

This application claims the benefit under 35 U.S.C. section 371, of PCT International Application No.: PCT/KR2020/000552, filed on Jan. 13, 2020, which claims foreign priority to Korean Patent Application No.: KR10-2019-0004886, filed on Jan. 14, 2019, in the Korean Intellectual Property Office, both of which are hereby incorporated by reference in their entireties.

### TECHNICAL FIELD

The present disclosure relates to a service provision method and apparatus for determining approval of multiple users and providing a service and, more specifically, to a method of obtaining approval of multiple users with respect to service execution when a single service is used by the multiple users.

### BACKGROUND ART

Conventionally, a single service is used by only a single user in general. However, service provision methods by which multiple users can use a single service have recently been disclosed.

Here, when a service used by a single user may damage other users, the single user can obtain approval of other users when the user uses the service to prevent users who do not use the service from being damaged by the service.

As disclosed in Korean unexamined patent application No. 10-2017-0136724, for example, when a provided service is a joint account based transfer service, a user can perform transfer only when the user obtains approval of other users.

However, when a user who does not use a service does not express intention to approve of using the service or intention not to approve separately from protection of the user who does not use the service, a user who intends to use the service is likely to be damaged.

Accordingly, there is need for a method capable of protecting both a user who intends to use a service and a user who does not use the service.

### DISCLOSURE

### Technical Problem

An object of the present disclosure is to provide a method capable of protecting both a user who intends to use a service and a user who does not use the service.

Technical objects to be achieved by the present disclosure are not limited to the aforementioned technical objects, and other technical objects not described above may be evidently understood by a person having ordinary skill in the art to which the present disclosure pertains from the following description.

### Technical Solution

To accomplish the object, a service provision apparatus according to an embodiment of the present disclosure includes: a memory storing n (n being a natural number equal to or greater than 2) secret keys respectively corresponding to n terminals, the n secret keys being used to execute a service executable by the n terminals jointly; and a processor configured to: perform authentication for a first terminal from among the n terminals on the basis of an electronic signature value generated in the first terminal when a service execution request for executing the service is received from the first terminal; request any one of the n secret keys and a message about approval or non-approval of the service execution for the n terminals when authentication of the first terminal is completed; check whether n secret keys received from the n terminals are consistent with the n secret keys stored in the memory when secret keys and messages about approval or non-approval are received from all the n terminals within a predetermined time; execute the service when the n secret keys received from the n terminals are consistent with the n secret keys stored in the memory and messages about approval of the service execution are received from all the n terminals; and re-request the secret key and the message about approval or non-approval when the n secret keys received from the n terminals are not consistent with the n secret keys stored in the memory, wherein, when at least one of the electronic signature value, the secret key value and the message about approval or non-approval is not received from at least one of other terminals within the predetermined time, the processor determines that the service execution request of the first terminal is approved.

### Advantageous Effects

The service provision apparatus according to the disclosed embodiment can protect both a user who intends to use a service and a user who does not use the service.

Effects which may be obtained by the present disclosure are not limited to the aforementioned effects, and other technical effects not described above may be evidently understood by a person having ordinary skill in the art to which the present disclosure pertains from the following description.

### DESCRIPTION OF DRAWINGS

FIGS. 1 and 2 illustrates a basic service provision method according to an embodiment of the present disclosure.

FIG. 3 is a flowchart schematically showing a service execution method according to an embodiment of the present disclosure.

FIG. 4 is a flowchart for describing a method of implicitly approving of a service request of a first terminal and executing a service when there is no response within a predetermined time.

FIGS. 5 to 7 are flowcharts for describing other methods of determining implicit approval according to an embodiment of the present disclosure.

### BEST MODE

To accomplish the aforementioned object, a service provision apparatus according to an embodiment of the present disclosure includes: a memory storing n (n being a natural number equal to or greater than 2) secret keys respectively corresponding to n terminals, the n secret keys being used to execute a service executable by the n terminals jointly; and a processor configured to: perform authentication for a first terminal from among the n terminals on the basis of an electronic signature value generated in the first terminal when a service execution request for executing the service is received from the first terminal; request any one of the n secret keys and a message about approval or non-approval of the service execution for the n terminals when authentication of the first terminal is completed; check whether n secret keys received from the n terminals are consistent with the n secret keys stored in the memory when secret keys and messages about approval or non-approval are received from all the n terminals within a predetermined time; execute the service when the n secret keys received from the n terminals are consistent with the n secret keys stored in the memory and messages about approval of the service execution are received from all the n terminals; and re-request the secret key and the message about approval or non-approval when the n secret keys received from the n terminals are not consistent with the n secret keys stored in the memory, wherein, when at least one of the electronic signature value, the secret key value and the message about approval or non-approval is not received from at least one of other terminals within the predetermined time, the processor determines that the service execution request of the first terminal is approved.

Here, the processor may determine that the n terminals approve of the service execution request of the first terminal when a control signal indicating that then terminals have confirmed the electronic signature request message or the secret keys and the message about approval or non-approval is received from the n terminals within a predetermined time, and determine that the n terminals do not approve of the service execution request of the first terminal when the control signal indicating that the n terminals have confirmed the electronic signature request message or the secret keys and the message about approval or non-approval is not received from the n terminals within the predetermined time.

Here, the processor may transmit one of a first index and a second index to each of the n terminals, determine that the service execution request of the first terminal is not approved when at least one of the electronic signature value, the secret key and the message about approval or non-approval is not received from at least one of terminals to which the first index has been transmitted within a predetermined time, and determine that the service execution request of the first terminal is approved when at least one of the electronic signature value, the secret key and the message about approval or non-approval is not received from at least one of terminals to which the second index has been transmitted within a predetermined time.

Here, the processor may determine that the service execution request of the first terminal is not approved when a cost corresponding to the service execution request received from the first terminal is equal to or greater than a predetermined cost and at least one of the electronic signature value, the secret key and the message about approval or non-approval is not received from at least one of the other terminals within the predetermined time, and determine that the service execution request of the first terminal is approved when the cost corresponding to the service execution request received from the first terminal is equal to or less than the predetermined cost and at least one of the electronic signature value, the secret key and the message about approval or non-approval is not received from at least one of the other terminals within the predetermined time.

Here, the service may be a joint account based transfer service with respect to a joint account jointly owned by users respectively corresponding to then terminals, and the processor may transfer an amount corresponding to the transfer service from a personal account of a user of the first terminal to the joint account when the transfer service is completed in a state in which at least one of the electronic signature value, the secret key value and the message about approval or non-approval is not received from at least one of the n terminals, and the electronic signature value, the secret key value and the message about approval or non-approval is received from the at least one terminal after transfer of the amount.

Here, the predetermined time may be determined on the basis of past response times received from the n terminals.

Here, the processor may determine the predetermined time by inputting time information about a time when the electronic signature value, the secret key value and the message about approval or non-approval of each of the n terminals are requested and a time when the electronic signature value, the secret key value and the message about approval or non-approval are received, and use environment information about the n terminals to an artificial intelligence model as input data.

To accomplish the aforementioned object, a service provision method according to another embodiment of the present disclosure includes the steps of: transmitting an electronic signature request message to a first terminal from among n terminals to receive a first electronic signature value generated in the first terminal from the first terminal and performing verification of the received first electronic signature value when a service execution request for executing a service is received from the first terminal; transmitting an electronic signature request message to terminals other than the first terminal from among the n terminals to receive electronic signature values respectively generated in the other terminals from the other terminals and performing verification of the electronic signature values received from the other terminals when verification of the first electronic signature value is completed; requesting any one of n secret keys and a message about approval or non-approval of the service execution for the n terminals when verification of the electronic signature values received from the other terminals is completed, the n secret keys being used to execute a service executable by the n terminals jointly; checking whether n secret keys received from the n terminals are consistent with n secret keys stored in a memory when secret keys and messages about approval or non-approval are received from all the n terminals within a predetermined time; executing the service when the n secret keys received from the n terminals are consistent with the n secret keys stored in the memory and messages about approval of the service execution are received from all the n terminals; re-requesting the secret key and the message about approval or non-approval when the n secret keys received from the n terminals are not consistent with the n secret keys stored in the memory; and, when at least one of the electronic signature value, the secret key value and the message about approval or non-approval is not received from at least one of the other terminals within the predetermined time, determining that the service execution request of the first terminal is approved.

To accomplish the aforementioned object, a computer program according to another embodiment of the present disclosure is stored in a computer-readable recording medium to be combined with a hardware computer to execute the method of claim 9.

Details of the present disclosure are included in the detailed description and drawings.

### Modes for Disclosure

The advantages and features of the present disclosure and the way of attaining them will become apparent with reference to embodiments described below in detail in conjunction with the accompanying drawings. The present disclosure, however, is not limited to the embodiments disclosed hereinafter and may be embodied in many different forms. Rather, these exemplary embodiments are provided so that this disclosure will be through and complete and will fully convey the scope to those skilled in the art. Thus, the scope of the present invention should be defined by the claims.

The technical terms used herein are used to merely describe embodiments and should not be construed as limiting the present disclosure. An element described in the singular form is intended to include a plurality of elements unless the context clearly indicates otherwise. In the present specification, when the terms “comprise” and/or “comprising” are used, other elements may be added unless the term “only” is used. The same reference numbers will be used throughout this specification to refer to the same or like parts, and “and/or” includes each of mentioned components and all combinations of one or more thereof. The terms “first” and “second” are used for the purpose of explanation about various components, and the components are not limited to the terms “first” and “second”. The terms “first” and “second” are only used to distinguish one component from another component. Accordingly, a first component mentioned below may be named as a second component without deviating from the scope of the present disclosure.

All the terms (including technical and scientific terms) used in the present specification agree with the meanings as understood by a person skilled in the art unless defined to the contrary. Common terms as found in dictionaries should be interpreted in the context of the related technical writings not too ideally or impractically unless this disclosure expressly defines them so.

The term “unit” or “module” used in the specification refers to software or a hardware component such as FPGA or ASIC and plays a certain role. However, the term “unit” or “module” is not limited to software or hardware. “Units” or “modules” may be configured to be stored in an addressable storage medium or configured to drive one or more processors. Accordingly, for example, “units” or “modules” include components such as software components, object-oriented software components, class components and task components, processes, functions, attributes, procedures, subroutines, segments of program code, drivers, firmware, microcode, circuits, data, databases, data structures, tables, arrays and variables. Function provided in components and “units” or “modules” may be combined into a smaller number of components and “units” or “modules” or separated into additional components and “units” or “modules”.

Spatially relative terms such as “below”, “beneath”, “lower”, “above” and “upper” may be used to easily describe a correlation between any one element and another element as illustrated in the drawings. It should be understood that spatially relative terms include different directions of components when the components are used or operated in addition to directions illustrated in the drawings. For example, when components illustrated in a drawing are reversed, a component described as being “below” or “beneath” another component may be placed “above” the other component. Accordingly, the exemplary term “below” may include both “beneath” and “above”. A component may be aligned in a different direction and thus spatially relative terms can be interpreted according to alignment.

In the specification, a terminal or a device refers to all kinds of hardware devices including at least one processor and it may be understood as meaning including a software component operating in a corresponding hardware device according to an embodiment. For example, it should be understood that a terminal or a device include a smartphone, a table PC, a desktop PC, a notebook PC, a server, and user clients and applications operating in each device and it is not limited thereto.

Electronic signature value verification used in the present disclosure may be interchangeably used with authentication.

Hereinafter, embodiments of the present disclosure will be described in detail with reference to the attached drawings.

Although each step described in the present specification is performed by a smartphone or a server, the subject of each step is not limited thereto and at least some of steps may be performed by different devices according to an embodiment.

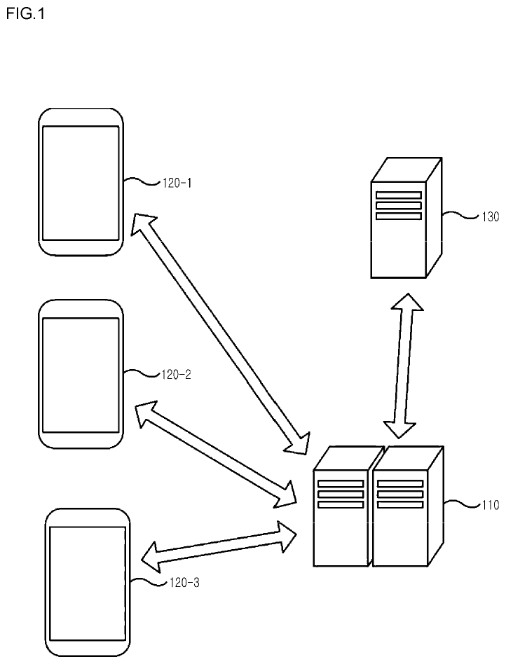

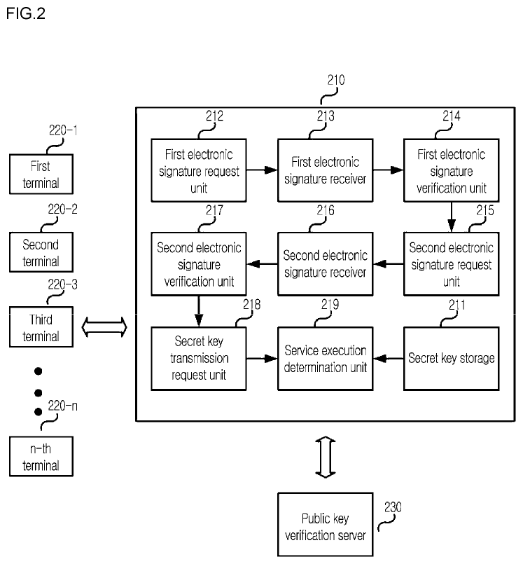

FIGS. 1 and 2 illustrate a basic service provision method according to an embodiment of the present disclosure.

FIG. 1 illustrates a system for describing the service provision apparatus according to an embodiment of the present disclosure.

As shown in FIG. 1, a service provision system may include a service provision apparatus 110, a plurality of terminals 120-1 to 120-3, and a public key verification server. Although FIG. 1 illustrates three terminals, two or more terminals may be provided. However, a case in which three terminals are provided is exemplified in the present disclosure for convenience of description.

The service provision apparatus 110 may include a memory and a processor. The processor may include a random access memory (RAM) (not shown) and a read only memory (ROM) (not shown) which temporarily and permanently store signals (or data) processed in the processor. In addition, the processor may be implemented as a system on chip (SoC) including at least one of a graphic processor, a RAM and a ROM. Programs (one or more instructions) for processing and control of the processor may be stored in the memory. The programs stored in the memory may be divided into a plurality of modules according to functions.

Here, the memory can store three different secret keys corresponding to the plurality of terminals. The service provision apparatus 110 can respectively transmit the three different secret keys to the three terminals 120-1 to 120-3.

The plurality of terminals 120-1 to 120-3 may store private keys necessary for authentication, public keys corresponding to the private keys, and the secret keys received from the service provision apparatus 110. For convenience of description, it is assumed that the first terminal 120-1 stores a first private key, a first public key and a first secret key, the second terminal 120-2 stores a second private key, a second public key and a second secret key, and the third terminal 120-3 stores a third private key, a third public key and a third secret key.

In an embodiment, when the service provision apparatus 110 receives a service execution request from the first terminal 120-1, the service provision apparatus 110 can perform authentication for the first terminal 120-1 on the basis of an electronic signature value generated in the first terminal 120-1. Specifically, when the service provision apparatus 110 receives a service execution request from the first terminal 120-1, the service provision apparatus 110 can generate a hash value by applying data corresponding to a requested service as an input value of a specific hash function and transmit the generated hash value to the first terminal 120-1 to request an electronic signature. Here, the data corresponding to the service may include information about the type of the service, cost information necessary for the service, information about a service provider, etc.

The first terminal 120-1 may generate a first electronic signature value by encoding the hash value using the first private key and transmit the generated first electronic signature value and the first public key to the service provision apparatus 110.

The service provision apparatus 110 may request that the public key verification server 130 verify the first public key received from the first terminal 120-1, decode the first electronic signature value on the basis of the first public key when it is confirmed that the first public key has been provided by the public key verification server 130 as a verification result, and verify whether the decoded value is identical to the hash value transmitted to the first terminal.

When the verification is completed, the service provision apparatus 110 can transmit the same hash value as that transmitted to the first terminal 120-1 to the second and third terminals 120-2 and 120-3.

Authentication for the second and third terminals 120-2 and 120-3 can be completed through the same method as the verification and authentication method of the first terminal 120-1. However, this is not a mandatory process and may be omitted in some cases. That is, the second terminal 120-2 (third terminal 120-3) can generate a second electronic signature value (a third electronic signature value) by encoding the hash value using the second private key (third private key) and transmit the generated second electronic signature value (third electronic signature value) and the second public key (third public key) to the service provision apparatus 110. The service provision apparatus 110 can request that the public key verification server 130 verify the second public key (third public key) received from the second terminal 120-2 (third terminal 120-3), decode the second electronic signature value (third electronic signature value) on the basis of the second public key (third public key) when it is confirmed that the second public key (third public key) has been provided by the public key verification server 130 as a verification result, and verify whether the decoded value is identical to the hash value transmitted to the first terminal.

Upon completion of authentication, the service provision apparatus 110 can request transmission of the secret keys of the terminals. Each terminal can transmit the secret key stored in the memory and a message about approval/non-approval of service execution to the service provision apparatus 110.

Specifically, the first terminal 120-1 can transmit the first secret key and a message about approval/non-approval of service execution to the service provision apparatus 110, the second terminal 120-2 can transmit the second secret key and a message about approval/non-approval of service execution to the service provision apparatus 110, and the third terminal 120-3 can transmit the third secret key and a message about approval/non-approval of service execution to the service provision apparatus 110. Here, the first terminal 120-1 that initially requests service execution may not transmit the message about approval/non-approval of service execution.

The service provision apparatus 110 can check whether the secret key received from each terminal is identical to a secret key stored in the memory. If the received secret key is identical to the stored secret key, the service provision apparatus 110 can determine whether to execute the service on the basis of the message received from each terminal. If the secret keys are not identical to each other, the service provision apparatus 110 can defer service execution or transmit, to a terminal which has transmitted a secret key that is not identical to the stored secret key, a message indicating that the secret key is wrong.

FIG. 2 is a block diagram showing a configuration of the service provision apparatus according to an embodiment of the present disclosure in detail.

As shown in FIG. 2, the service provision apparatus 110 may include a secret key storage 211, a first electronic signature request unit 212, a first electronic signature receiver 213, a first electronic signature verification unit 214, a second electronic signature request unit 215, a second electronic signature receiver 216, a second electronic signature verification unit 217, a secret key transmission request unit 218, and a service execution determination unit 219.

Specifically, each component may be stored in the form of a program in the memory and executed by the processor.

The first electronic signature request unit 212, the first electronic signature receiver 213 and the first electronic signature verification unit 214 are components for electronic signature value verification of a terminal (the first terminal 120-1 in the present specification) which requests service execution and the second electronic signature request unit 215, the second electronic signature receiver 216 and the second electronic signature verification unit 217 are components for electronic signature value verification of other terminals. The first electronic signature request unit 212, the first electronic signature receiver 213, the first electronic signature verification unit 214, the second electronic signature request unit 215, the second electronic signature receiver 216 and the second electronic signature verification unit 217 may be configured as a single electronic signature request unit, a single electronic signature receiver and a single electronic signature verification unit or configured as a plurality of electronic signature request units, a plurality of electronic signature receivers and a plurality of electronic signature verification units corresponding to respective terminals as necessary.

The secret key transmission request unit 218 is a component for requesting secret key transmission from a plurality of terminals 120-1 to 120-3 when electronic signature value verification of other terminals is completed, and the service execution determination unit 219 can determine whether to execute a service on the basis of messages about approval/non-approval of service execution transmitted along with secret keys from the plurality of terminals 120-1 to 120-3 when correct secret keys are transmitted from the plurality of terminals 120-1 to 120-3. For example, when the plurality of terminals 120-1 to 120-3 transmits messages about approval of service execution, the service execution determination unit 219 can execute the service requested by the first terminal 120-1. As another example, when a part of the plurality of terminals 120-1 to 120-3 transmits a message about approval of service execution and other terminals transmit messages about non-approval of service execution, the service execution determination unit 219 may not execute the service requested by the first terminal 120-1. Alternatively, when a part of the plurality of terminals 120-1 to 120-3 transmits a message about approval of service execution and other terminals transmit messages about non-approval of service execution, the service execution determination unit 219 may determine whether to execute the service requested by the first terminal 120-1 according to the ratio of approval messages to non-approval messages or according to preset priorities of the terminals which have transmitted approval messages and non-approval messages (for example, when a high priority terminal transmits a message about non-approval of service execution, service execution can be rejected irrespective of a result of transmission of an approval message of the next-priority terminal) or the percentages thereof.

Furthermore, the service execution determination unit 219 can determine whether to execute the service when the secret key of any one of the plurality of terminals 120-1 to 120-3 is erroneously transmitted or electronic signature value verification is not completed through various methods as in various embodiments which will be described later.

Meanwhile, a service described in the present disclosure may include various services. In an embodiment, a service according to the present disclosure may be a banking service in which a plurality of users uses a single joint account. Alternatively, a service according to the present disclosure may be a payment service in which a plurality of users uses a single debit card or a credit card.

Alternatively, a service according to the present disclosure may be an Internet service in which a plurality of users uses a single Internet service. For example, a plurality of users may have their IDs and passwords and a service used by the plurality of users may be an Internet shopping basket sharing service. In this case, although the users log in using different IDs, they access the same account.

Alternatively, a service according to the present disclosure may be a paid service used by a plurality of users. For example, a plurality of users can use a service with respect to a single piece of content (e-book, movie, or the like).

Alternatively, a service according to the present invention may be a membership service in which a plurality of users uses a single paid-up membership purchase card. In this case, the purchase card may be composed of a plurality of cards including IDs of the plurality of users, but a single payment account may be provided for the plurality of cards.

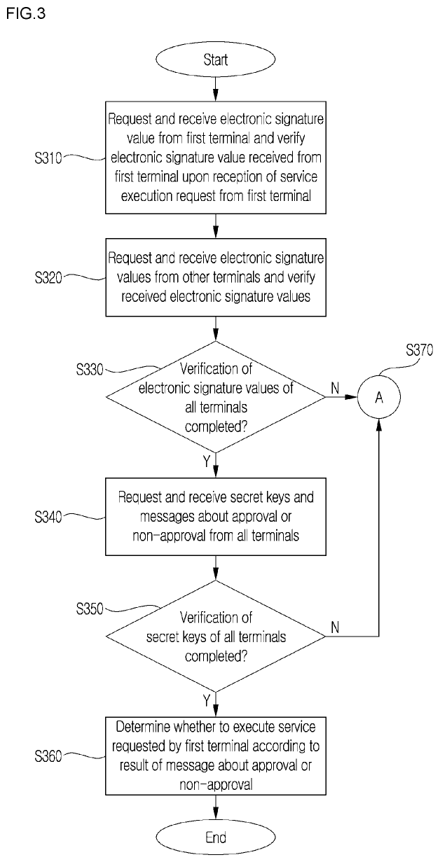

FIG. 3 is a flowchart schematically showing a service execution method according to an embodiment of the present disclosure.

As shown in FIG. 3, when a service execution request is received from the first terminal 120-1, the service provision apparatus 110 may request an electronic signature value from the first terminal 120-1, receive the electronic signature value and verifies the electronic signature value received from the first terminal 120-1 (S310).

When verification of the electronic signature value received from the first terminal 120-1 is completed, the service provision apparatus 110 may request electronic signature values from other terminals 120-2 and 120-3, receive the electronic signature values and verify the received electronic signature values (S320). S320 may be omitted as necessary.

The service provision apparatus 110 may determine whether verification of electronic signature values of all terminals is completed (S330). When verification of electronic signature values of all terminals is completed (Y in S330), the service provision apparatus 110 may request and receive secret keys and messages about approval/non-approval of service execution from all of the terminals (S340).

The service provision apparatus 110 may verify the secret keys received from the terminals (S350). When verification of the secret keys received from the terminals is completed (Y in S350), the service provision apparatus 110 may determine whether to execute a service requested by the first terminal 120-1 on the basis of the messages about approval/non-approval of service execution received from the terminals (S360).

When verification of electronic signature values or secret keys of all terminals is not completed, the service provision apparatus 110 proceeds to step A (S370). However, when the messages about approval/non-approval of service execution are not received as well as the electronic signature values and secret keys, the procedure may proceed to step A.

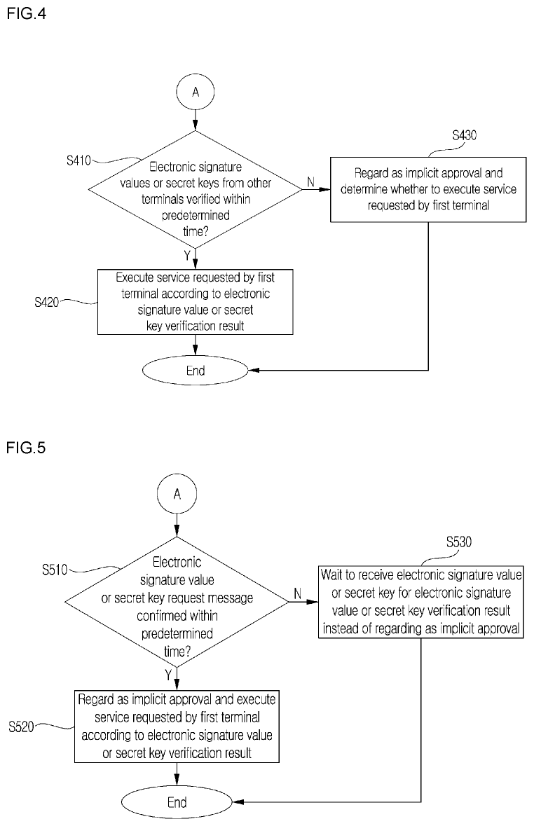

FIGS. 4 to 7 are flowcharts for describing various methods for determining service execution according to the present disclosure.

FIG. 4 is a flowchart for describing a method of implicitly approving of a service request of the first terminal and determining that a service will be executed when there is no response within a predetermined time.

Specifically, when verification of the electronic signature value from any one of the other terminals 120-2 and 120-3 is not completed (N in S330) or verification of the secret key from any one of all terminals is not completed (N in S350), the service provision apparatus 110 may determine whether verification of electronic signature values or secret keys from other terminals, which have not been verified within a predetermined time, is completed (S410).

Here, the predetermined time may be determined through various methods. In an embodiment, the predetermined time may be determined according to setting or agreement of a user. In another embodiment, the predetermined time may be determined on the basis of past response times of the plurality of terminals. Here, a past response time may be a time from when a terminal receives an electronic signature value or secret key request message to completion of response to message reception, or a time from when the terminal confirms reception of an electronic signature value or secret key request message to completion of response to message reception. For example, when an average past response time of the first terminal 120-1 is 10 minutes, an average past response time of the second terminal 120-2 is 8 minutes, and an average past response time of the third terminal 120-3 is 6 minutes, the predetermined time may be determined as 8 minutes that is the average of 10 minutes, 8 minutes and 6 minutes, 10 minutes that is the longest time from among 10 minutes, 8 minutes and 6 minutes, or 6 minutes that is the shortest time from among 10 minutes, 8 minutes and 6 minutes. Alternatively, the predetermined time may be individually determined for each of the plurality of terminals. For example, when an average past response time of the first terminal 120-1 is 10 minutes, an average past response time of the second terminal 120-2 is 8 minutes, and an average past response time of the third terminal 120-3 is 6 minutes, 10 minutes may be determined as the predetermined time for the first terminal 120-1, 8 minutes may be determined as the predetermined time for the second terminal 120-2, and 6 minutes may be determined as the predetermined time for the third terminal 120-3.

Here, when verification of electronic signature values or secret keys is completed within the predetermined time (Y in S410), the service provision apparatus 110 may execute the service requested by the first terminal 120-1 according to an electronic signature value or secret key verification result. Specifically, the service provision apparatus 110 may determine whether to execute the service on the basis of the messages about approval of service execution transmitted along with the secret keys from the terminals. As described above, when the plurality of terminals 120-1 to 120-3 transmits messages about approval of service execution, the service execution determination unit 219 can execute the service requested by the first terminal 120-1. As another example, when a part of the plurality of terminals 120-1 to 120-3 transmits a message about approval of service execution and other terminals transmit messages about non-approval of service execution, the service execution determination unit 219 may not execute the service requested by the first terminal 120-1. As another example, when a part of the plurality of terminals 120-1 to 120-3 transmits a message about approval of service execution and other terminals transmit messages about non-approval of service execution, the service execution determination unit 219 may determine whether to execute the service requested by the first terminal 120-1 according to the ratio of approval messages to non-approval messages or according to preset priorities or percentages of the terminals which have transmitted approval messages and non-approval messages.

On the other hand, when verification of electronic signature values or secret keys is not completed within the predetermined time (N in S410), the service provision apparatus 110 may consider that a terminal having an electronic signature value or secret key that has not been verified has transmitted a message about approval of service execution and determine whether to execute the service requested by the first terminal 120-1. For example, when the second terminal 120-2 has transmitted a message about approval of service execution within the predetermined time and the electronic signature value or secret key of the third terminal 120-3 has not been verified, the service provision apparatus 110 can determine that the third terminal 120-3 approves of service execution and execute the service requested by the first terminal 120-1.

FIG. 5 is a flowchart for describing another method of determining implicit approval according to an embodiment of the present disclosure.

First, when verification of the electronic signature value from any one of the other terminals 120-2 and 120-3 is not completed (N in S330) or verification of the secret key from any one of all terminals is not completed (N in S350), the service provision apparatus 110 may determine whether the terminal for which verification is not completed confirms the electronic signature value or secret key request message within a predetermined time (S510).

Specifically, when a service execution request is received from the first terminal 120-1 and verification of the electronic signature value of the first terminal 120-1 is completed, the service provision apparatus 110 may transmit an electronic signature value request message or a secret key request message to necessary terminals. Here, the electronic signature value request message or the secret key request message may further include an index for checking whether the message is received. That is, the service provision apparatus 110 can determine a situation in which a user of a terminal has not received the message due to a system error or cannot confirm the contents of the message although the message has been received because the terminal is not managed, or the like through the index for checking whether the message is received.

When a terminal for which electronic signature value or secret key verification is not completed confirms the electronic signature value or secret key request message within the predetermined time (Y in S510), the service provision apparatus 110 may consider that the terminal for which the electronic signature value or secret key verification is not completed has transmitted a message about approval of service execution and determine whether to execute the service requested by the first terminal 120-1 (S520). That is, the service provision apparatus 110 may determine that the user of the terminal implicitly approves of service execution upon determination that the user of the terminal has received a message with respect to service approval but does not respond to the message intentionally. Accordingly, it is possible to execute the service while considering intentions of the user of the first terminal 120-1 and users of other terminals.

However, when the terminal for which electronic signature value or secret key verification is not completed does not confirm the electronic signature value or secret key request message within the predetermined time (N in S510), the service provision apparatus 110 may wait to receive an electronic signature value or a secret key for electronic signature value or secret key verification instead of regarding the state in which the electronic signature value or secret key request message is not confirmed as implicit approval. Through the aforementioned process, it is possible to effectively satisfy a service execution request of a terminal that requests a service and prevent the service from being executed without confirmation of the request for the service to protect users of other terminals.

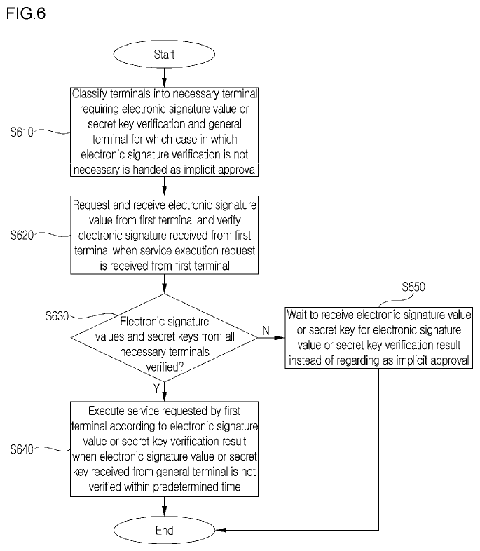

FIG. 6 is a flowchart for describing another method of determining implicit approval according to an embodiment of the present disclosure.

Specifically, the service provision apparatus 110 may classify terminals into a terminal necessary for service execution and a general terminal, may not handle a case in which an electronic signature value or a secret key is not received from a necessary terminal within a predetermined time as implicit approval, and may handle a case in which an electronic signature value or a secret key is not received from a general terminal as implicit approval.

First, the service provision apparatus 110 may classify the plurality of terminals 120-1 to 120-3 into a necessary terminal whose electronic signature value or secret key is required to be verified and a general terminal for which no verification of an electronic signature value is handled as implicit approval (S610). Various classification methods may be provided as necessary. In an embodiment, the service provision apparatus 110 may classify terminals into a necessary terminal and a general terminal by transmitting a first index to the necessary terminal, adding a second index to the general terminal, and receiving the first index or the second index transmitted to the terminal when an electronic signature value or a secret key is received.

In another embodiment, the service provision apparatus 110 may assign priority orders to all terminals and classify the terminals into a necessary terminal and a general terminal according to preset criteria. For example, when four terminals are present, the service provision apparatus may respectively transmit first to fourth indices to the terminals. Here, priority orders may be determined in the order of the first to fourth indices. The service provision apparatus 110 can classify the terminals into a necessary terminal and a general terminal according to preset criteria (for example, criteria for designating terminals having the first to third indices as necessary terminals or criteria for designating terminals having the first and second indices as necessary terminals).

When a service execution request is received from the first terminal 120-1, the service provision apparatus 110 may request and receive an electronic signature value from the first terminal 120-1 and verify the electronic signature value received from the first terminal (S620). Using the same method, the service provision apparatus 110 may verify electronic signature values from the other terminals. Secret key verification can also be performed through the aforementioned method. That is, although not shown, the service provision apparatus 110 may verify electronic signature values and secret keys through the same method as S310 to S350 of FIG. 3.

The service provision apparatus 110 may determine whether verification of electronic signature values and secret keys of all necessary terminals is completed (S630).

When verification of electronic signature values and secret keys of all necessary terminals is completed (Y in S630), the service provision apparatus 110 may check whether electronic signature values or secret keys received from general terminals have been verified within a predetermined time, and when the electronic signature values or secret keys received from the general terminals have not been verified within the predetermined time, execute the service requested by the first terminal 120-1 according to an electronic signature value or secret key verification result (S640).

When verification of electronic signature values and secret keys of all necessary terminals is not completed (N in S630), the service provision apparatus 110 may wait to receive electronic signature values or secret keys for electronic signature value or secret key verification instead of determining no response of necessary terminals as implicit approval (S650).

That is, the service provision apparatus 110 may handle no response of a general terminal as implicit approval and may not handle no response of a necessary terminal as implicit approval.

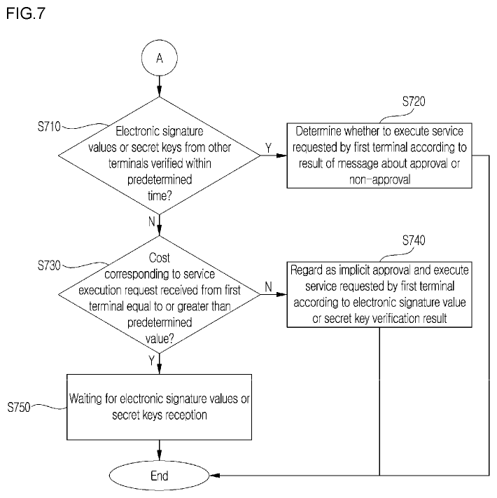

FIG. 7 is a flowchart for describing another method of determining implicit approval according to an embodiment of the present disclosure.

When verification is not completed (N in S330) or verification of a secret key from any one of all terminals is not completed (N in S350), the service provision apparatus 110 may determine whether verification of an electronic signature value or secret key request message for other terminals is completed within a predetermined time (S710).

When electronic signature value and secret key verification for all terminals is completed (Y in S710), the service provision apparatus 110 may determine whether to execute the service requested by the first terminal 120-1 according to results of approval/non-approval.

When electronic signature value and secret key verification for all terminals is not completed (N in S710), the service provision apparatus 110 may determine whether a cost corresponding to the service execution request received from the first terminal 120-1 is equal to or greater than a predetermined value (S730). Here, the predetermined value may be determined through various methods. For example, the predetermined value may be determined according to agreement of a plurality of users. Alternatively, when a service provided by the service provision apparatus 110 is a joint account service, the predetermined value may be a fixed rate of the amount of cash present in a joint account (for example, 10% of the amount that can be drawn from the account). Alternatively, a service 110 provided by the service provision apparatus 110 is a joint account service, the predetermined value may be a value depending on a rate of the amount deposited by each of a plurality of users in a joint account.

When the cost corresponding to the service execution request received from the first terminal 120-1 is equal to or greater than the predetermined value (Y in S730), the service provision apparatus 110 may wait to receive electronic signature values or secret keys (S750). However, when the cost corresponding to the service execution request received from the first terminal 120-1 is less than the predetermined value (N in S730), the service provision apparatus 110 may regard no response of a terminal as implicit approval of service execution and execute the service requested by the first terminal 120-1 according to results of verification of electronic signature values or secret keys of other terminals.

That is, since obtaining approval of all users for use of all services even in the case of low costs is burdensome for a service request user, the service provision apparatus 110 can protect a service requester by processing service execution when there is no response for a predetermined time for costs less than a predetermined value.

Meanwhile, although the above-described various embodiments can be independently applied, they may be applied in a combined manner as necessary.

In an embodiment, when some terminals do not confirm the message within the predetermined time in the embodiment of FIG. 5, the service provision apparatus 110 can also determine no response of a general terminal as implicit approval and determine whether to execute the service if the cost corresponding to the service execution request of the first terminal 120-1 is less than the predetermined value or electronic signature value and secret key verification is completed for all necessary terminals or all necessary terminals confirm the message.

In another embodiment, when electronic signature value and secret key verification is not completed for some necessary terminals in the embodiment of FIG. 6, the service provision apparatus 110 can also determine no response of a general terminal as implicit approval and determine whether to execute the service if the cost corresponding to the service execution request of the first terminal 120-1 is less than the predetermined value.

In another embodiment, even when the cost corresponding to the service execution request of the first terminal 120-1 is equal to or greater than the predetermined value in the embodiment of FIG. 7, the service provision apparatus 110 can determine no response of a general terminal as implicit approval and determine whether to execute the service if electronic signature value and secret key verification is completed for all necessary terminals.

Meanwhile, various values or conditions according to the present disclosure may be acquired through an artificial intelligence model.

For example, the service provision apparatus 110 may determine the predetermined time by inputting time information about a time when electronic signature values, secret keys and messages about approval/non-approval from a plurality of terminals are requested and a time when the electronic signature values, secret keys and messages about approval/non-approval are received, and use environment information about the plurality of terminals to an artificial intelligence model as input data.

Alternatively, the service provision apparatus 110 may receive use environment information from each terminal and input the use environment information to the artificial intelligence model as input data to determine the predetermined time. Here, use environment information may include information about a time for which a user uses a terminal, information about whether the user uses another function of the terminal, time information, and the like.

That is, the service provision apparatus 110 can determine whether a user of a terminal can approve of service execution at a time when a service execution request is received by learning not only a time taken for the user to complete electronic signature value and secret key verification but also a terminal use habit of the user. For example, if a user of the second terminal 120-2 does not often use the terminal from 3 p.m. to 6 p.m., the service provision apparatus 110 can set a time at which the predetermined time for determining implicit approval ends to a time after 6 p.m.

Alternatively, the service provision apparatus 110 may determine whether a terminal user approves of a service request by inputting data with respect to past approval/non-approval of a plurality of terminal users for a service execution request as input data. Here, data with respect to approval/non-approval for a service execution request may be information about sharing of a service, a cost required to execute the service, approval or non-approval of service execution, and the like. That is, when a user does not respond to a service execution request, the service provision apparatus 110 can determine whether to approve of a currently requested service on the basis of past information of the user. In an embodiment, the service provision apparatus 110 may determine whether to approve of a requested service on the basis of information about a time when each terminal is mainly used, information about a message reception checking time of each terminal, information about services for which payment is approved for each terminal, information about costs of services for which payment is approved for each terminal, and the like. For example, when any one of a plurality of terminals always approved of service execution for services requiring a specific cost (e.g., fifty thousand won) or less, the service provision apparatus 110 can determine that the corresponding terminal will approve of service request even if the terminal does not provide an electronic signature value or a secret key for a predetermined time. Otherwise, when any one of a plurality of terminals always approved of service execution for services requiring costs less than that of a specific service (e.g., movie service), the service provision apparatus 110 can determine that the corresponding terminal will approve of service request even if the terminal does not provide an electronic signature value or a secret key for a predetermined time.

A result of determination of approval/non-approval may be used when the above-described implicit approval conditions are satisfied. For example, when the second terminal 120-2 does not complete electronic signature value or secret key verification for a predetermined time, the service provision apparatus 110 may approve or may not approve of service execution according to a determination result.

To use the aforementioned artificial intelligence model, the service provision apparatus 110 may include a data learning unit for learning the artificial intelligence model and a data recognition unit for using the learnt artificial intelligence model. The data learning unit and the data recognition unit may be manufactured in the form of a dedicated hardware chip for at least one artificial intelligence (AI) or may be manufactured as a part of a conventional general-purpose processor (e.g., a CPU or an application processor) or a graphic dedicated processor (e.g., GPU). Here, a dedicated hardware chip for artificial intelligence is a dedicated processor specialized for probability calculation and has higher parallel processing performance than conventional general-purpose processors and thus can rapidly process calculation operation in AI applications.

Such AI models may include models such as a DNN (Deep Neural Network), an RNN (Recurrent Neural Network) and a BRDNN (Bidirectional Recurrent Deep Neural Network), but the present disclosure is not limited thereto.

Steps of methods or algorithms described with respect to embodiments of the present disclosure may be implemented by hardware, a software module executed by hardware or a combination thereof. A software module may reside in a RAM (Random Access Memory), a ROM (Read Only Memory), an EPROM (Erasable Programmable ROM), an EEPROM (Electrically Erasable Programmable ROM), a flash memory, a hard disk, a detachable disc, a CD-ROM, or any type of computer-readable recording medium known in the field of the present disclosure.

Components of the present disclosure may be implemented by a program (or application) to be combined with a computer that is hardware and executed thereby and stored in a medium. The components of the present disclosure may be executed by software programming or software elements. Similarly, embodiments may be implemented by programming or scripting languages such as C, C++, Java and assembler including various algorithms realized by data structures, processes, routines or a combination of other programming components. Functional parts may be implemented by an algorithm executed in one or more processors.

Although embodiments of the present disclosure have been described with reference to the attached drawings, those skilled in the art will appreciate that the present disclosure may be carried out in other specific ways than those set forth herein without departing from the spirit and essential characteristics of the present disclosure. Accordingly, the above embodiments are therefore to be construed in all aspects as illustrative and not restrictive.

1. A service provision apparatus, comprising:
a memory storing n (n being a natural number equal to or greater than 2) secret keys respectively corresponding to n terminals, the n secret keys being used to execute a service executable by the n terminals jointly; and
a processor configured to:
perform authentication for a first terminal from among the n terminals on the basis of an electronic signature value generated in the first terminal when a service execution request for executing the service is received from the first terminal;
request any one of the n secret keys and a message about approval or non-approval of the service execution for the n terminals when authentication of the first terminal is completed;
check whether n secret keys received from the n terminals are consistent with the n secret keys stored in the memory when secret keys and messages about approval or non-approval are received from all the n terminals within a predetermined time;
execute the service when the n secret keys received from the n terminals are consistent with the n secret keys stored in the memory and messages about approval of the service execution are received from all the n terminals; and
re-request the secret key and the message about approval or non-approval when the n secret keys received from the n terminals are not consistent with the n secret keys stored in the memory,
wherein, when at least one of the electronic signature value, the secret key value and the message about approval or non-approval is not received from at least one of other terminals within the predetermined time, the processor determines that the service execution request of the first terminal is approved.

2. The service provision apparatus of claim 1, wherein the service is at least one of a banking service in which a plurality of users uses a single joint account, a payment service in which a plurality of users uses a single debit card or credit card, an Internet service in which a plurality of users uses a single Internet service, a paid service in which a plurality of users uses a single paid service, and a membership service in which a plurality of users uses a single paid-up membership purchase card.

3. The service provision apparatus of claim 1, wherein the processor determines that the n terminals approve of the service execution request of the first terminal when a control signal indicating that the n terminals have confirmed the electronic signature request message or the secret keys and the message about approval or non-approval is received from the n terminals within a predetermined time, and
determines that the n terminals do not approve of the service execution request of the first terminal when the control signal indicating that the n terminals have confirmed the electronic signature request message or the secret keys and the message about approval or non-approval is not received from the n terminals within the predetermined time.

4. The service provision apparatus of claim 1, wherein the processor transmits one of a first index and a second index to each of the n terminals,
determines that the service execution request of the first terminal is not approved when at least one of the electronic signature value, the secret key and the message about approval or non-approval is not received from at least one of terminals to which the first index has been transmitted within a predetermined time, and
determines that the service execution request of the first terminal is approved when at least one of the electronic signature value, the secret key and the message about approval or non-approval is not received from at least one of terminals to which the second index has been transmitted within a predetermined time.

5. The service provision apparatus of claim 1, wherein the processor determines that the service execution request of the first terminal is not approved when a cost corresponding to the service execution request received from the first terminal is equal to or greater than a predetermined cost and at least one of the electronic signature value, the secret key and the message about approval or non-approval is not received from at least one of the other terminals within the predetermined time, and
determines that the service execution request of the first terminal is approved when the cost corresponding to the service execution request received from the first terminal is equal to or less than the predetermined cost and at least one of the electronic signature value, the secret key and the message about approval or non-approval is not received from at least one of the other terminals within the predetermined time.

6. The service provision apparatus of claim 1, wherein the service is a joint account based transfer service with respect to a joint account jointly owned by users respectively corresponding to the n terminals, and
wherein the processor transfers an amount corresponding to the transfer service from a personal account of a user of the first terminal to the joint account when the transfer service is completed in a state in which at least one of the electronic signature value, the secret key value and the message about approval or non-approval is not received from at least one of the n terminals, and the electronic signature value, the secret key value and the message about approval or non-approval is received from the at least one terminal after transfer of the amount.

7. The service provision apparatus of claim 1, wherein the predetermined time is determined on the basis of past response times received from the n terminals.

8. The service provision apparatus of claim 1, wherein the processor determines the predetermined time by inputting time information about a time when the electronic signature value, the secret key value and the message about approval or non-approval of each of the n terminals are requested and a time when the electronic signature value, the secret key value and the message about approval or non-approval are received, and use environment information about the n terminals to an artificial intelligence model as input data.

9. A service provision method, comprising the steps of:
transmitting an electronic signature request message to a first terminal from among n terminals to receive a first electronic signature value generated in the first terminal from the first terminal and performing verification of the received first electronic signature value when a service execution request for executing a service is received from the first terminal;
transmitting an electronic signature request message to terminals other than the first terminal from among the n terminals to receive electronic signature values respectively generated in the other terminals from the other terminals and performing verification of the electronic signature values received from the other terminals when verification of the first electronic signature value is completed;
requesting any one of n secret keys and a message about approval or non-approval of the service execution for the n terminals when verification of the electronic signature values received from the other terminals is completed, the n secret keys being used to execute a service executable by the n terminals jointly;
checking whether n secret keys received from the n terminals are consistent with n secret keys stored in a memory when secret keys and messages about approval or non-approval are received from all then terminals within a predetermined time;
executing the service when the n secret keys received from the n terminals are consistent with the n secret keys stored in the memory and messages about approval of the service execution are received from all the n terminals;
re-requesting the secret key and the message about approval or non-approval when the n secret keys received from the n terminals are not consistent with the n secret keys stored in the memory; and
when at least one of the electronic signature value, the secret key value and the message about approval or non-approval is not received from at least one of the other terminals within the predetermined time, determining that the service execution request of the first terminal is approved.

10. A computer program stored in a computer-readable recording medium to execute the method of claim 9 by being combined with a hardware computer.
